(19) United States
(12) Patent Application Publication
(10) Pub. No.: US 2016/0164612 A1
(43) Pub. Date: Jun. 9, 2016

(54) WAVELENGTH DIVISION MULTIPLEXING (WDM)/DEMULTIPLEXING OPTICAL TRANSCEIVER MODULE AND METHOD COMPATIBLE WITH SINGLE MODE AND MULTIMODE OPTICAL FIBER

(71) Applicant: Avago Technologies General IP (Singapore) Pte. Ltd., Singapore (SG)

(72) Inventors: John Wilks, San Fransisco, CA (US); Waruna Fernando, San Jose, CA (US); Robert Hannah, San Jose, CA (US); Sunil Priyadarshi, Sunnyvale, CA (US)

(21) Appl. No.: 14/558,840

(22) Filed: Dec. 3, 2014

(51) Int. Cl. H04B 10/40; H04J 14/02

(52) U.S. Cl. CPC H04B 10/40; H04J 14/02

(57) ABSTRACT

A wavelength division multiplexing/demultiplexing optical transceiver module is provided that is suitable for use in single mode optical fiber (SMF) and multimode optical fiber (MMF) optical communications links. When used in an MMF optical communications link, the optical transceiver module allows the length and bandwidth of the link to be increased significantly. The optical transceiver module can be used advantageously in an MMF link that includes existing MMF infrastructure to increase the bandwidth of the MMF link while avoiding the costs associated with pulling new higher-bandwidth fiber.

### TECHNICAL FIELD OF THE INVENTION

The invention relates to optical fiber networks and, more particularly, to optical transceiver modules, optical links, and methods that increase the bandwidth of multimode optical fiber links.

### BACKGROUND OF THE INVENTION

In optical communications networks, optical transceiver modules are used to transmit and receive optical signals over optical fibers. An optical transceiver module includes a transmitter side and a receiver side. On the transmitter side, a laser light source generates modulated laser light and an optical coupling system receives the modulated laser light and optically couples, or images, the light onto an end of an optical fiber. The laser light source is typically a laser diode or light emitting diode (LED) that generates light of a particular wavelength or wavelength range. A driver circuit of the transmitter side outputs electrical drive signals that modulate the laser diode or LED. The optical coupling system typically includes one or more reflective, refractive and/or diffractive elements. On the receiver side, the optical signal passing out of the end of an optical fiber is optically coupled onto a photodiode by an optical coupling system of the transceiver module. The photodiode converts the optical signal into an electrical signal. Receiver circuitry of the receiver side processes the electrical signal to recover the data. The transmitter side may have one or more than one laser diode or LED and the receiver side may have one or more than one photodiode.

Some high-speed optical transceiver modules use wavelength division multiplexing (WDM) to increase communication channel bandwidth. In WDM optical transceiver modules, multiple light sources generate light of multiple respective wavelengths and the light is wavelength division multiplexed into the end of the same optical fiber. Such optical transceiver modules are designed as either single mode optical transceiver modules that are only compatible with single mode optical fiber (SMF) or as multimode optical transceiver modules that are only compatible with multimode optical fiber (MMF).

Single mode optical transceiver modules offer greater link distance, but this typically comes with a higher module cost due to the tighter manufacturing tolerances required for launching an optical signal into a SMF. The diameters of the cores of SMFs are much smaller than the diameters of the cores of MMFs, which leads to the tighter manufacturing tolerances for single mode optical transceiver modules. The core diameter of SMF typically ranges from about 8 to 10.5 micrometers and the core diameter of MMF typically ranges from about 50 to 62.6 micrometers. The larger diameters of the cores of MMFs allow multimode optical transceiver modules to have much more relaxed manufacturing tolerances than single mode optical transceiver modules. However, multimode optical transceiver modules cannot achieve the same link distance performance as their single mode variants due to bandwidth limitations inherent in operating multimode sources over MMF. For these reasons, single mode optical transceiver modules are deployed primarily in longer optical links (over 600 meters), while multimode optical transceiver modules are deployed primarily in data centers in optical links having lengths of 600 meters or less.

As data centers move from interconnect speeds of 10 gigabit per second (Gb/s) to interconnect speeds of 40 Gb/s and beyond, there is a strong desire by the data center operators to maintain the existing MMF infrastructure due to the costs associated with pulling new SMF. Accordingly, a need exists for an approach that allows the existing MMF infrastructure to be used while also increasing the link bandwidth.

### SUMMARY OF THE INVENTION

The invention is directed to an optical transceiver module that uses wavelength division multiplexing in combination with mode conditioning to enhance bandwidth and increase link length. In accordance with an illustrative embodiment, the optical transceiver module comprises N light sources, an N-to-1 wavelength division multiplexer (WDM), and a mode conditioning device, where N is a positive integer that is greater than or equal to 2. The N light sources produce N optical signals of different respective wavelengths. The N-to-1 WDM inputs the N optical signals and outputs a multiplexed optical signal of the N wavelengths. The mode conditioning device receives the multiplexed optical signal and is configured to launch the multiplexed optical signal into an end face of a proximal end of an optical fiber of an optical communication link to excite predominantly a fundamental light mode in the optical fiber.

In accordance with another illustrative embodiment, the optical transceiver module comprises a mode conditioning device, a 1-to-N wavelength division optical demultiplexer (WDDM), and N light detectors. The mode conditioning device receives a multiplexed optical signal comprising N optical signals of N different respective wavelengths passing out of a distal end of an optical fiber of an optical communication link. The mode conditioning device is configured to filter out light modes from the multiplexed optical signal other than a fundamental light mode of the multiplexed optical signal. The 1-to-N WDDM inputs the filtered multiplexed optical signal and outputs N optical signals of the N respective wavelengths. The N light detectors detect the respective optical signals of the N optical signals of N different respective wavelengths and produce N respective electrical signals.

In accordance with another illustrative embodiment, the optical transceiver module comprises an optical transmitter and an optical receiver. The optical transmitter comprises a plurality of light sources, a WDM, and a first optical coupling system. The light sources produce a plurality of respective optical signals of different respective wavelengths. The WDM inputs the optical signals and outputs a multiplexed optical signal of the plurality of wavelengths. The first optical coupling system receives the multiplexed optical signal. The first optical coupling system is configured or adapted to launch the multiplexed optical signal into an end face of a proximal end of an optical fiber of an optical communication link to excite predominantly a fundamental light mode in the optical fiber. The optical receiver comprises a second optical coupling system, a WDDM, and a plurality of light detectors. The second optical coupling system receives a multiplexed optical signal comprising a plurality of wavelengths passing out of a distal end of the optical fiber of the optical communication link. The second optical coupling device is configured to filter out light modes from the multiplexed optical signal other than a fundamental light mode of the multiplexed optical signal. The WDDM inputs the filtered multiplexed optical signal and outputs a plurality of optical signals of the respective wavelengths. The light detectors detect respective optical signals of the respective wavelengths and produce a plurality of respective electrical signals.

These and other features and advantages of the invention will become apparent from the following description, drawings and claims.

### BRIEF DESCRIPTION OF THE DRAWINGS

FIG. 1 illustrates a block diagram of first and second optical transceiver modules connected to proximal and distal ends of an MMF of an optical communications link in accordance with an illustrative embodiment.

FIG. 2 illustrates a perspective view of the mode conditioning device of the first optical transceiver module shown in FIG. 1 interfaced on a proximal end to an output port of the optical WDM MUX of the first optical transceiver module and interfaced on a second end to the proximal end of the MMF.

FIG. 3 illustrates a side plan view of the MMF shown in FIGS. 1 and 2 with its end face in abutment with an end face of the mode conditioning device of the second optical transceiver module shown in FIG. 1.

FIG. 4 illustrates a side plan view of SMF with its end face in abutment with an end face of the mode conditioning device of the second optical transceiver module shown in FIG. 1.

### DETAILED DESCRIPTION OF AN ILLUSTRATIVE EMBODIMENT

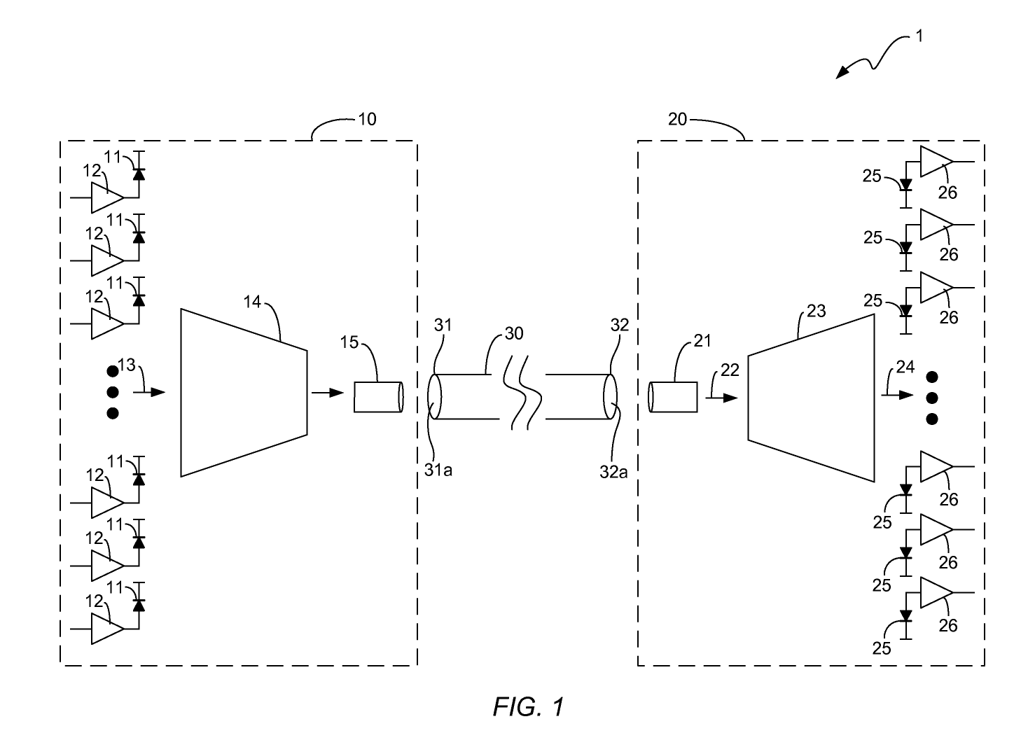

In accordance with illustrative, or exemplary, embodiments described herein, a wavelength division multiplexing/demultiplexing optical transceiver module is provided that is suitable for use in SMF and MMF optical communications links. When used in an MMF optical communications link, the optical transceiver module allows the length and bandwidth of the link to be increased significantly. The optical transceiver module can be used advantageously in an MMF link that includes existing MMF infrastructure to increase the bandwidth of the MMF link while avoiding the costs associated with pulling new higher-bandwidth fiber. Illustrative embodiments of the optical transceiver module and of an MMF optical communications link in which it is used will now be described with reference to FIGS. 1-4, in which like reference numerals represent like components, elements or features.

FIG. 1 illustrates an MMF optical communications link 1 having first and second optical transceiver modules 10 and 20 connected to proximal and distal ends 31 and 32, respectively, of an MMF 30. For ease of illustration, only the transmitter side of the first optical transceiver module 10 and the receiver side of the second optical transceiver module 20 are shown in FIG. 1. The first optical transceiver module 10 will typically also include a receiver side similar or identical to the receiver side of optical transceiver module 20 shown in FIG. 1. Likewise, the second optical transceiver module 20 will typically also include a transmitter side similar or identical to the transmitter side of optical transceiver module 20 shown in FIG. 1. The optical transceiver modules 10 and 20 also have respective module housings, which are not shown for ease of illustration and discussion.

In accordance with an illustrative embodiment, the optical transceiver module 10 is a WDM optical transceiver module having N single mode light sources (e.g., laser diodes or LEDs) 11 that emit N optical signals of N respective wavelengths, where N is a positive integer that is greater than or equal to 2. The WDM capability of the WDM optical transceiver module 10 increases the bandwidth of the MMF link 1 by using multiple wavelengths to simultaneously carry multiple data signals over the link 1. The optical transceiver module 10 includes N light source driver circuits 12 for driving the N respective light sources 11 to cause them to emit N optical signals 13, an optical N-to-1 multiplexer (MUX) 14 for optically multiplexing the N optical signals 13 emitted by the N light sources 11 into one optical signal 14 of N wavelengths, and a mode conditioning device 15 that provides a controlled launch of the optical signal 14 onto the end face 31a of proximal end 31 of MMF 30.

The mode conditioning device 15 is essentially an optical coupling system that optically couples light from the output of the MUX 14 to the end face 31a of the proximal end 31 of the MMF 30. It should be noted, however, that the optical coupling system may include additional components, such as reflective, refractive and/or diffractive optical elements. The mode conditioning device 15 is designed to provide a controlled launch that excites only the fundamental mode of the MMF. By exciting only the fundamental mode, modal dispersion in the MMF is reduced or eliminated. Reducing or eliminating modal dispersion increases the bandwidth of the MMF 30 by allowing optical signals of higher data rates to be carried on the MMF 30. In addition, reducing or eliminating modal dispersion allows the link length to be increased.

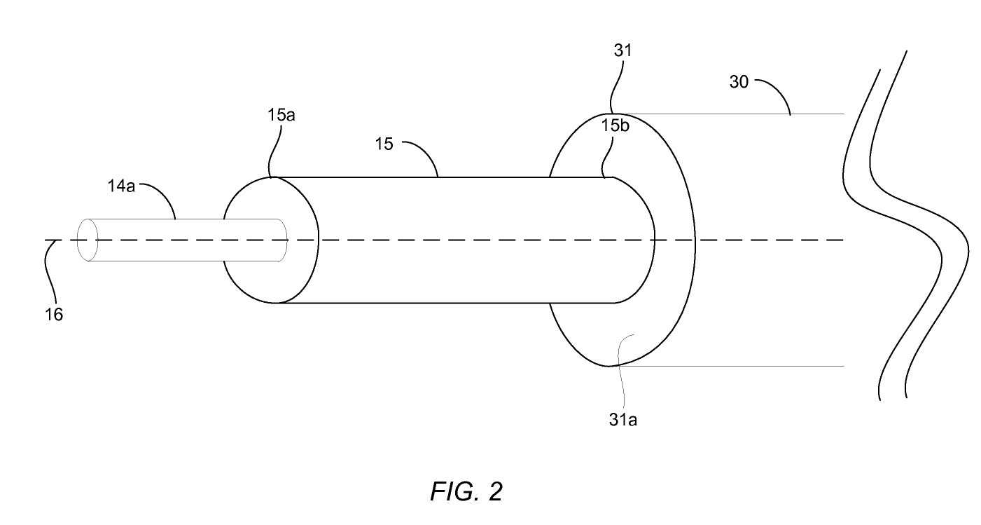

The mode conditioning device 15 may be, for example, a gradient refractive index (GRIN) lens or an optical fiber stub positioned relative to the end face 31a of the MMF 30 to ensure that the optical signal being coupled from the mode conditioning device 15 into the end face 31a excites only the fundamental mode in the MMF 30. FIG. 2 illustrates a perspective view of the mode conditioning element 15 in accordance with an illustrative embodiment in which the mode conditioning device 15 is an optical fiber stub. A proximal end 15a of the optical fiber stub 15 is connected to the output port 14a of the optical MUX 14. The output port 14a typically has a diameter of about 9 micrometers (microns). A distal end 15b of the optical fiber stub 15 is connected to the proximal end 31 of the MMF 30. The fiber stub 15 has a diameter that is larger than a diameter of the output port 14a of the MUX 14 and smaller than a diameter of the MMF 30. The output port 14a of the MUX 14, the fiber stub 15 and the MMF 30 are axially aligned along a common optical axis 16. The fiber stub 15 couples the light received from the output port 14a of the MUX 14 into a central region of the MMF, which results in only the fundamental mode of the light being excited in the MMF 30. As indicated above, exciting only the fundamental mode in the MMF 30 reduces or eliminates modal dispersion, which provides benefits in terms of increased link bandwidth and increased link length.

The controlled launch provided by the mode conditioning device 15 onto the end face 31a provides very high optical coupling efficiency. In addition, all modes other than the fundamental mode (LP₀₁) are substantially filtered out by the mode conditioning device 15. For example, for a link MMF having a 50-micron diameter core, providing the mode conditioning device 15 with a mode field diameter (MFD) of about 14 microns achieves nearly ideal optical coupling efficiency. The mode conditioning device 15 provides relatively high optical coupling efficiency over a range of MFDs ranging from about 8 microns to about 25 microns while still providing relatively low optical coupling efficiency for the higher order modes (LP₀₂-LP₀₅). The desired MFD can be achieved by using a GRIN lens that focuses the light to a spot having the MFD on the end face 31a or by using a fiber stub with a core of the MFD.

The second optical transceiver module 20 is a wavelength division demultiplexing (WDDM) optical transceiver module. The WDDM optical transceiver module 20 includes a mode conditioning device 21 that receives an optical signal passing out of an end face 32a of a distal end 32 of the MMF 30. The mode conditioning device 21 filters out any higher order modes of the optical signal passing out of the end face 32a and delivers the filtered optical signal 22 to a 1-to-N Wide Numerical Aperture (WNA) optical demultiplexer (DeMUX) 23. The proximal and distal ends 31 and 32 of the MMF 30 are typically connected to respective optical ports of the optical transceiver modules 10 and 20, respectively, by respective optical connectors (not shown). If there is any misalignment between the optical connector and the optical port of the transceiver module 10, the end face 31a will not be precisely aligned with the mode conditioning device 15. The misalignment can result in an offset launch condition that excites modes in addition to the fundamental mode. The mode conditioning device 21 is designed or configured to filter out modes other than the fundamental mode.

The mode conditioning device 21 is essentially an optical coupling system that optically couples light from the end face 32a of the distal end 32 of the MMF 30 into the input of the WNA DeMUX 23. It should be noted, however, that the optical coupling system may include additional components, such as reflective, refractive and/or diffractive optical elements.

The filtered optical signal 22 is demultiplexed by the WNA DeMUX 23 into N optical signals 24 of N respective optical wavelengths. As will be understood by those of skill in the art, in view of the description provided herein, the DeMUX 23 includes optical elements that separate the optical signal 22 into the N optical signals 24 and direct the N optical signals 24 onto N respective optical detectors 25. The optical detectors 25 are typically photodiodes or P-intrinsic-N (PIN) diodes. The optical detectors 25 produce N respective electrical signals based on the N optical signals received by them. The receiver side of the optical transceiver module 20 typically includes N amplifier circuits 26 that amplify the respective electrical signals. The amplifier circuits may be, for example, limiting amplifier circuits of the type that are commonly used with P-I-N photodiodes in optical transceiver modules of various types.

One of the benefits of using a WNA DeMux is that the wide numerical aperture ensures that all modes passed by the mode conditioning device 21 are efficiently coupled to the optical detectors 25. Uneven optical coupling can result in received power fluctuations if the MMF 30 is subjected to transient mechanical perturbations.

Optical wavelength division MUXes and DeMUXes that are suitable for use as the optical MUX 14 and WNA DeMUX 23 are available in the industry. Therefore, a detailed description of the optical elements of the MUX 14 and WNA DeMUX 23 that perform the wavelength division multiplexing and demultiplexing operations will not be described herein in the interest of brevity. Also, while the mode conditioning devices 15 and 21 are shown as individual components, they may be integrated into other components of the transceiver modules 10 and 20, such as the MUX 14 and WNA DeMUX 23, respectively. Alternatively, the mode conditioning devices 15 and 21 may be integrated into the cable that holds the MMF 30 or into the connectors (not shown) that are used to connect the ends 31 and 32 of the MMF 30 to the transceiver modules 10 and 20, respectively.

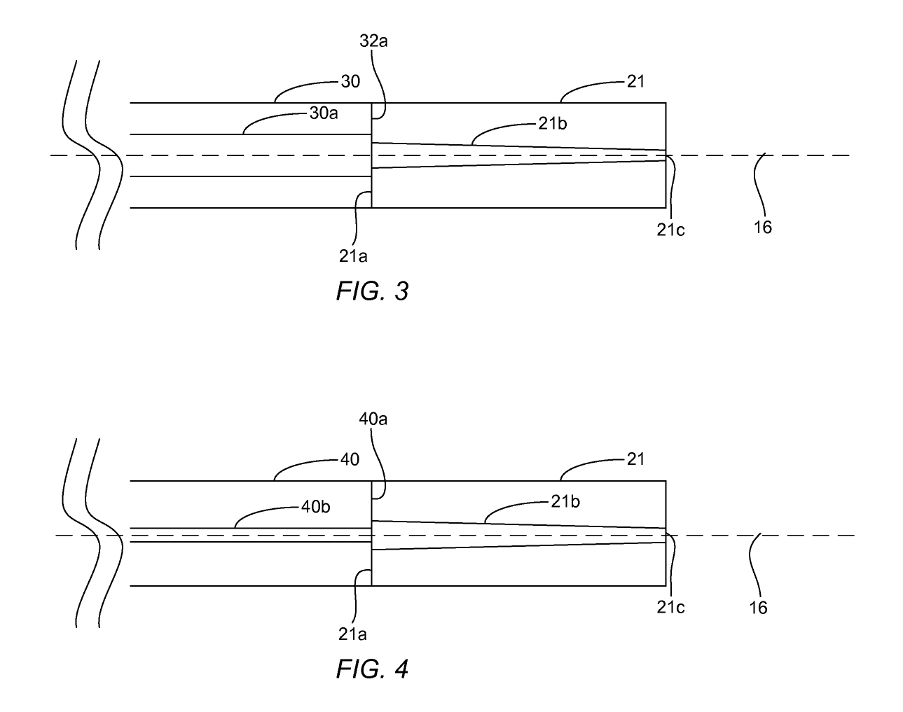

FIG. 3 illustrates a side plan view of the MMF 30 shown in FIGS. 1 and 2 with its end face 32a in abutment with an end face 21a of the mode conditioning device 21. In accordance with this illustrative embodiment, the mode conditioning device 21 is an optical fiber stub having a tapered core 21b that has its largest diameter at the end face 21a and tapers down to its smallest diameter at the opposite end face 21c. The core 30a of the MMF 30 has a diameter that is larger than the maximum diameter of the core 21b and the cores 30a and 21b are coaxially aligned along the common optical axis 16. The MMF 30 typically has a diameter ranging from about 50 microns to about 62.5 microns. The core 21b has a maximum diameter at the interface with the MMF 30 that ranges from about 14 microns to about 50 microns. By providing the fiber stub 21 with a core 21b that has a diameter that is slightly smaller than the diameter of the core 30a of the MMF 30 and by coaxially aligning the cores 30a and 21b, the optical coupling efficiency of light being coupled from the core 30a into the core 21b is relatively high, but most of the light that is coupled into the core 21b is of the fundamental mode. The tapering of the core 21b further filters out any other mode groups so that light passing out of the end face 21c is only light of the fundamental mode.

The versatility of the optical transceiver modules 10 and 20 that allows them to be used in SMF and MMF optical links is demonstrated by FIG. 4, which illustrates a side plan view of an SMF 40 with its end face 40a in abutment with the end face 21a of the optical fiber stub 21 shown in FIG. 3. The core 40b of the SMF 40 has a diameter that is slightly smaller than the maximum diameter of the core 21b and the cores 40b and 21b are coaxially aligned along the common optical axis 16. The SMF 40 typically has a diameter of about 10 microns. Because the core 21b of the stub 21 has a diameter that is slightly larger (ranging from about 14 to 50 microns) than the diameter of the core 40b of the SMF 40 and because the cores 40b and 21b are coaxially aligned, substantially all of the light is coupled from the core 40b into the core 21b and almost all of the light is of the fundamental mode. Again, the tapering of the core 21b further filters out any other mode groups so that light passing out of the end face 21c is only light of the fundamental mode.

As is apparent from the foregoing description of the illustrative embodiments, the configurations of the optical transceiver modules 10 and 20 enable the bandwidth and the length of an MMF optical link to be increased by: (1) using multiple single mode light sources and wavelength division multiplexing to allow multiple optical data signals of respective wavelengths to be simultaneously carried on the MMF; (2) using a mode conditioning device on the transmit end of the MMF link to excite only the fundamental mode of the emitted light, thereby preventing or at least reducing modal dispersion; and (3) using a mode conditioning device on the receive end of the MMF link to filter out any higher order modes and using a WNA DeMUX to ensure even optical coupling of the filtered light onto the optical detectors, thereby preventing or reducing the occurrence of power fluctuations in the received signal. It is not necessary to use all of these features together, as benefits can be achieved by using one or more of them, but using all of these features together provides a very powerful solution for increasing the bandwidth and length of an MMF link.

It should be noted that while the mode conditioning device 15 is designed to perform a controlled launch that only excites the fundamental mode of the MMF, any unintended misalignment between the end face 31a of the MMF 30 and the output facet of the mode conditioning device 15 can result in some higher order modes of the MMF 30 inadvertently being excited. Therefore, while the mode conditioning device 15 predominantly excites the fundamental mode, it is possible that other higher order modes may be excited to a lesser degree. Similarly, while the mode conditioning device 21 is designed to filter out all modes other than the fundamental mode, it is possible that small amounts of energy of one or more other modes will not be filtered out. In other words, the mode conditioning device 21 filters out all, or substantially all, modes other than the fundamental mode. It should also be noted that while optical fiber stubs and GRIN lenses have been mentioned herein as examples of suitable mode conditioning devices, other mode conditioning devices that accomplish the same functions may be used for this purpose.

The term “optical transceiver module,” as that term is used herein, is intended to denote (1) an optical transmitter module that has transmit functionality, but not receive functionality, (2) an optical receiver module that has receive functionality, but not transmit functionality, and (3) an optical transmitter/receiver module that has both transmit and receive functionality. Thus, the optical transceiver module 10 shown in FIG. 1 may or may not also include the receiver components 21, 23, 25, and 26 and the optical transceiver module 20 shown in FIG. 1 may or may not also include the transmitter components 11, 12, 14, and 15.

It should be noted that the invention has been described with reference to a few illustrative embodiments for the purposes of demonstrating the principles and concepts of the invention. For example, while the illustrative embodiment shown in FIG. 1 depicts the optical transceiver modules 10 and 20 as having particular arrangements of components, the transceiver modules 10 and 20 may have other arrangements or configurations of components or features and may have components in addition to those shown, e.g., a module housing, optical elements for dictating or folding the optical pathway, monitor photodiodes and optics for monitoring the optical intensity of the light emitted by the light sources 12, controller chips for controlling the operations of the modules 10 and 20, receiver chips for decoding the electrical signals produced by the light detectors 25, filter circuitry for filtering the electrical signals produced by the detectors 25, clock and data recovery (CDR) circuitry, equalization circuitry, etc. The invention is not limited to the illustrative embodiments, as will be understood by persons of ordinary skill in the art in view of the description provided herein. Those skilled in the art will understand that many modifications may be made to the embodiments described herein within the scope of the invention.

What is claimed is:

1. An optical transceiver module comprising:
N light sources that produce N optical signals of different respective wavelengths, where N is a positive integer that is greater than or equal to 2;
an N-to-1 wavelength division optical multiplexer (WDM) that inputs the N optical signals and outputs a multiplexed optical signal of the N wavelengths; and
a mode conditioning device that receives the multiplexed optical signal, and wherein the mode conditioning device is configured to launch the multiplexed optical signal into an end face of a proximal end of an optical fiber of an optical communication link to excite predominantly a fundamental light mode in the optical fiber.

2. The optical transceiver module of claim 1, wherein the light sources are single mode light sources.

3. The optical transceiver module of claim 2, wherein the optical fiber is a single mode optical fiber (SMF).

4. The optical transceiver module of claim 2, wherein the optical fiber is a multimode optical fiber (MMF).

5. The optical transceiver module of claim 2, wherein the optical transceiver module is compatible for use with single mode optical fiber (SMF) and with multimode optical fiber (MMF).

6. The optical transceiver module of claim 5, wherein the mode conditioning device is an optical fiber stub having a core with a maximum diameter that is smaller than a diameter of a core of the optical fiber of the communications link.

7. The optical transceiver module of claim 6, wherein if the optical fiber of the communications link is an MMF having a core diameter of about 50 micrometers (microns), the maximum diameter of the core of the optical fiber stub is in a range of from about 8 microns to about 25 microns.

8. The optical transceiver module of claim 5, wherein the mode conditioning device is a gradient refractive index (GRIN) lens that directs a spot of light onto the end face of the optical fiber of the communications link, wherein the spot has a diameter that is smaller than a diameter of a core of the optical fiber of the communications link.

9. The optical transceiver module of claim 8, wherein if the optical fiber of the communications link is an MMF having a core diameter of about 50 micrometers (microns), the maximum diameter of the spot is in a range of from about 8 microns to about 25 microns.

10. An optical transceiver module comprising:
a mode conditioning device that receives a multiplexed optical signal comprising N optical signals of N different respective wavelengths passing out of a distal end of an optical fiber of an optical communication link, wherein the mode conditioning device is configured to filter out light modes from the multiplexed optical signal other than a fundamental light mode of the multiplexed optical signal;
a 1-to-N wavelength division optical demultiplexer (WDDM) that inputs the filtered multiplexed optical signal and outputs N optical signals of the N respective wavelengths; and
N light detectors that detect respective optical signals of the N optical signals of N different respective wavelengths and produce N respective electrical signals.

11. The optical transceiver module of claim 10, wherein the N optical signals of the multiplexed optical signal are optical signals that have been produced by N respective single mode light sources.

12. The optical transceiver module of claim 11, wherein the optical fiber is a multimode optical fiber (MMF).

13. The optical transceiver module of claim 12, wherein the mode conditioning device is an optical fiber stub having a core with a maximum diameter that is less than or equal to a diameter of a core of the MMF.

14. The optical transceiver module of claim 13, wherein the core of the MMF has a diameter of about 50 micrometers (microns) and wherein the maximum diameter of the core of the optical fiber stub ranges from about 14 microns to about 50 microns.

15. The optical transceiver module of claim 12, wherein the core of the optical fiber stub is a tapered core having the maximum diameter at a proximal end of the stub that is nearest the MMF and having a minimum diameter at a distal end of the stub that is farthest from the MMF.

16. The optical transceiver module of claim 12, wherein the optical transceiver module is compatible for use with single mode optical fiber (SMF) and with multimode optical fiber (MMF).

17. The optical transceiver module of claim 16, wherein the optical fiber is a single mode optical fiber (SMF).

18. The optical transceiver module of claim 17, wherein the WDDM is a wide numerical aperture (WNA) WDDM.

19. The optical transceiver module of claim 18, wherein the mode conditioning device is an optical fiber stub having a core with a maximum diameter that is larger than a diameter of a core of the SMF.

20. The optical transceiver module of claim 19, wherein the core of the SMF has a diameter of about 10 micrometers (microns) and wherein the maximum diameter of the core of the optical fiber stub ranges from about 14 microns to about 50 microns.

21. The optical transceiver module of claim 19, wherein the core of the optical fiber stub is a tapered core having the maximum diameter at a proximal end of the stub that is nearest the SMF and having a minimum diameter at a distal end of the stub that is farthest from the SMF.

22. An optical transceiver module comprising:
an optical transmitter comprising,
a plurality of light sources that produce a plurality of respective optical signals of different respective wavelengths,
a wavelength division optical multiplexer (WDM) that inputs the optical signals and outputs a multiplexed optical signal of the plurality of wavelengths, and
a first optical coupling system that receives the multiplexed optical signal, and wherein the first optical coupling system is configured or adapted to launch the multiplexed optical signal into an end face of a proximal end of an optical fiber of an optical communication link to excite predominantly a fundamental light mode in the optical fiber; and
an optical receiver comprising,
a second optical coupling system that receives a multiplexed optical signal comprising a multiplexed optical signal of a plurality of wavelengths passing out of a distal end of the optical fiber of the optical communication link, wherein the second optical coupling device is configured to filter out light modes from the multiplexed optical signal other than a fundamental light mode of the multiplexed optical signal; <a wavelength division optical demultiplexer (WDDM) that inputs the filtered multiplexed optical signal and outputs a plurality of optical signals of the respective wavelengths; and
a plurality of light detectors that detect respective optical signals of the respective wavelengths and produce a plurality of respective electrical signals.

23. The optical transceiver module of claim 22, wherein the optical fiber is a multimode optical fiber (MMF).

24. The optical transceiver module of claim 23, wherein the first optical coupling system is an optical fiber stub having a core with a maximum diameter that is smaller than a diameter of a core of the MMF.

25. The optical transceiver module of claim 24, wherein the MMF has a core diameter of about 50 micrometers (microns) and wherein the maximum diameter of the core of the optical fiber stub is in a range of from about 8 microns to about 25 microns.

26. The optical transceiver module of claim 23, wherein the first optical coupling system is a gradient refractive index (GRIN) lens that directs a spot of light onto the end face of the MMF, wherein the spot has a diameter that is smaller than the diameter of a core of the MMF.

27. The optical transceiver module of claim 25, wherein if the MMF has a core diameter of about 50 micrometers (microns), the maximum diameter of the spot is in a range of from about 8 microns to about 25 microns.

28. The optical transceiver module of claim 22, wherein the optical transceiver module is compatible for use with single mode optical fiber (SMF) and with multimode optical fiber (MMF).

29. The optical transceiver module of claim 22, wherein the optical fiber of the optical communications link is a single mode optical fiber (SMF).

30. The optical transceiver module of claim 29, wherein the second optical coupling system is an optical fiber stub having a core with a maximum diameter that is larger than a diameter of a core of the SMF.

31. The optical transceiver module of claim 30, wherein the core of the optical fiber stub is a tapered core having the maximum diameter at a proximal end of the stub that is nearest the SMF and having a minimum diameter at a distal end of the stub that is farthest from the SMF.

32. The optical transceiver module of claim 22, wherein the optical fiber of the optical communications link is a multimode optical fiber (MMF).

33. The optical transceiver module of claim 32, wherein the second optical coupling system is an optical fiber stub having a core with a maximum diameter that is smaller than a diameter of a core of the SMF.

34. The optical transceiver module of claim 33, wherein the core of the optical fiber stub is a tapered core having the maximum diameter at a proximal end of the stub that is nearest the MMF and having a minimum diameter at a distal end of the stub that is farthest from the MMF.
